(19) United States
(12) Patent Application Publication
(10) Pub. No.: US 2026/0280270 A1
(43) Pub. Date: Sep. 17, 2026

(54) OPEN PROTECTION CIRCUIT AND SWITCHING REGULATOR

(71) Applicant: ABLIC INC., Nagano (JP)

(72) Inventor: Kaoru SAKAGUCHI, Nagano (JP)

(21) Appl. No.: 19/543,555

(22) Filed: Feb. 18, 2026

(30) Foreign Application Priority Data
Mar. 11, 2025 (JP) 2025-037989

(51) Int. Cl. H02H 3/20

(52) U.S. Cl. CPC H02H 3/20

(57) ABSTRACT

An open protection circuit includes a circuit for feedback-controlling an output voltage of an output terminal to a predetermined voltage. At least one of a plurality of voltage detection terminals connected to the output terminal is connected to a path for feedback-controlling. The open protection circuit compares the voltages of the plurality of voltage detection terminals and stops an output of the output voltage in response to detecting a predetermined potential difference.

### CROSS-REFERENCE TO RELATED APPLICATIONS

This application claims the priority of Japanese patent application No. 2025-037989, filed on Mar. 11, 2025, the entire contents of which are hereby incorporated herein by reference.

### BACKGROUND

### Technical Field

The present invention relates to an open protection circuit and a switching regulator.

### Description of Related Art

In a switching power supply, in case of a voltage detection terminal for feedback-controlling being open, the output voltage will increase abnormally, and sometimes causing damage to the load. A switching power supply including an open protection circuit that safely reduces the output voltage in case of the feedback terminal being open is known (e.g., Patent Document 1, Japanese Patent Application Laid-Open Publication No. 2022-95857).

In the open protection circuit described in Patent Document 1, if the deviation of the resistance value of the output voltage dividing resistor or the deviation of the current value of the constant current source is large, sometimes the protective action during open circuit may not work. That is, due to the deviation of elements within the integrated circuit, sometimes the protective action may not work in the case of the voltage detection terminal for feedback-controlling being open.

An aspect of the present invention provides an open protection circuit that an overvoltage in an output voltage in the case of a voltage detection terminal for feedback-controlling being open may be reliably prevented, regardless of the deviation of elements within an integrated circuit.

### SUMMARY

The open protection circuit of one embodiment of the present invention is an open protection circuit having a circuit for feedback-controlling an output voltage of an output terminal to a predetermined voltage, wherein at least one of a plurality of voltage detection terminals connected to the output terminal is connected to a path for feedback-controlling, and wherein the open protection circuit compares the voltages of the plurality of voltage detection terminals and stops an output of the output voltage in response to detecting a predetermined potential difference.

The switching regulator of one embodiment of the present invention is characterized in that the switching regulator includes the above-mentioned open protection circuit.

### BRIEF DESCRIPTION OF THE DRAWINGS

FIG. 1 is a diagram illustrating a switching regulator of the first embodiment;

FIG. 2 is a diagram illustrating a switching regulator according to the second embodiment;

FIG. 3 is a diagram illustrating a first example of the structure of comparison circuit according to various embodiments;

FIG. 4 is a diagram illustrating a second example of the structure of comparison circuit according to various embodiments of the present invention.

### DETAILED DESCRIPTION OF EMBODIMENTS

According to one embodiment of the present invention, an overvoltage in an output voltage in the case of a voltage detection terminal for feedback-controlling being open may be reliably prevented, regardless of the deviation of elements within an integrated circuit.

### First Embodiment

Below, the embodiments of the present invention will be described in detail with reference to the accompanying drawings.

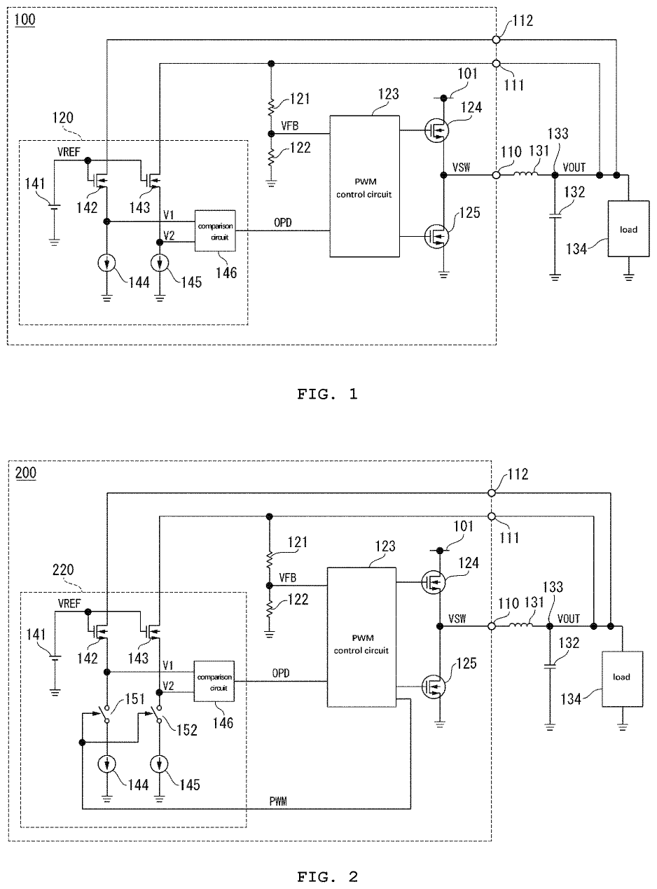

FIG. 1 is a diagram illustrating the switching regulator according to this embodiment. The switching regulator 100 according to this embodiment includes a switch terminal 110, a voltage detection terminal 111, a voltage detection terminal 112, an open protection circuit 120, a voltage dividing resistor 121, a voltage dividing resistor 122, a PWM control circuit 123, a high side FET 124, and a low side FET 125. In addition, the switching regulator 100 includes an inductor 131, a capacitor 132, and an output terminal 133.

In addition, the voltage detection terminal 111 is an example of a second voltage detection terminal. The voltage detection terminal 112 is an example of the first voltage detection terminal.

The PWM control circuit 123 controls the ON and OFF of the high side FET 124 and the low side FET 125 based on a pulse width modulation (PWM) control, respectively. The PWM control circuit 123 performs this PWM control so that the output voltage VOUT becomes a predetermined value. The PWM control circuit 123 uses this PWM control to let the external power supply voltage from the external power supply path 101 intermittently pass, generating a switch terminal voltage VSW at the switch terminal 110. The high side FET 124 and low side FET 125 are N-type MOS transistors respectively.

The high side FET 124 supplies external power supply voltage from the external power supply voltage supplying path 101 to the drain, the gate of the high side FET 124 is connected to one output terminal of the PWM control circuit 123, and the source of the high side FET 124 is connected to the switch terminal 110 and the drain of the low side FET 125. The gate of the low side FET 125 is connected to the other output terminal of the PWM control circuit 123, the drain of the low side FET 125 is connected to the source of the high side FET 124 and the switch terminal 110, and the source of the low side FET 125 is grounded.

The inductor 131 and capacitor 132 smooth the switch terminal voltage VSW. The smoothed switch terminal voltage VSW is output as the output voltage VOUT. The inductor 131 is provided between a switch terminal 110 and an output terminal 133. The capacitor 132 includes a first end (lower side in FIG. 1) and a second end (upper side in FIG. 1). The second end of capacitor 132 is connected to the output terminal 133. The first end of the capacitor 132 is grounded.

The output voltage VOUT is supplied to the voltage detection terminal 111. The output voltage VOUT supplied to the voltage detection terminal 111 is divided by the voltage dividing resistors 121 and 122, thereby obtaining the feedback voltage VFB. The feedback voltage VFB is input into the PWM control circuit 123. The PWM control circuit 123 controls the feedback voltage VFB to become a certain voltage.

One end of the voltage dividing resistor 121 is connected to the voltage detection terminal 111, and the other end of the voltage dividing resistor 121 is connected to the voltage dividing resistor 122. One end of the voltage dividing resistor 122 is connected to the voltage dividing resistor 121, and the other end of the voltage dividing resistor 122 is grounded. The input terminal of the PWM control circuit 123 is connected between the voltage dividing resistor 121 and the voltage dividing resistor 122.

In addition, the output voltage VOUT output from the output terminal 133 is supplied to the voltage detection terminal 112. In addition, the output voltage VOUT output from the output terminal 133 is provided to a load 134.

The open protection circuit 120 includes a reference voltage source 141, a transistor 142, a transistor 143, a constant current source 144, a constant current source 145, and a comparison circuit 146.

In addition, the open protection circuit 120 is an example of the open protection circuit. The reference voltage source 141 is an example of the reference voltage source. The transistor 142 is an example of the first transistor. The transistor 143 is an example of the second transistor. The constant current source 144 is an example of the first current source. The constant current source 145 is an example of the second current source. The comparison circuit 146 is an example of the comparison circuit.

The transistor 142 is an NMOS transistor. The drain of the transistor 142 is connected to the voltage detection terminal 112, the gate of the transistor 142 is connected to the reference voltage source 141, and the source of the transistor 142 is connected to the constant current source 144.

The transistor 143 is an NMOS transistor. The drain of the transistor 143 is connected to the voltage detection terminal 111, the gate of the transistor 143 is connected to the reference voltage source 141, and the source of the transistor 143 is connected to the constant current source 145. As described above, the voltage detection terminal 111 is connected to the feedback path to the PWM control circuit 123, which includes the voltage dividing resistor 121 and the voltage dividing resistor 122. The transistor 142 and the transistor 143 are composed of elements with the same type as each other.

One end of the constant current source 144 is connected to the source of transistor 142, and the other end of the constant current source 144 is grounded. One end of the constant current source 145 is connected to the source of the transistor 143, and the other end of the constant current source 145 is grounded. The current value of the constant current source 144 is equal to the current value of the constant current source 145.

The reference voltage source 141 has a first terminal and a second terminal that generates a voltage that is higher than the voltage of the first terminal by the reference voltage VREF. The first terminal is grounded. The second terminal is connected to the gate of the transistor 142 and the gate of the transistor 143. Therefore, the reference voltage source 141 supplies voltages to the gate of the transistor 142 and the gate of the transistor 143, respectively.

The comparison circuit 146 compares the source voltage V1 of the transistor 142 with the source voltage V2 of the transistor 143. The comparison circuit 146 has a first input terminal and a second input terminal. The first input terminal of the comparison circuit 146 is connected between the source of the transistor 142 and the constant current source 144. The second input terminal of the comparison circuit 146 is connected between the source of the transistor 143 and the constant current source 145. The comparison circuit 146 generates an output signal OPD corresponding to the comparison result of the source voltage V1 and the source voltage V2, and outputs the output signal OPD to the PWM control circuit 123.

In the open protection circuit 120, as described above, the transistor 142 and the transistor 143 are composed of elements with the same type as each other, and the current value of the constant current source 144 is equal to the current value of the constant current source 145. Therefore, during the normal operation of the switching regulator 100, the source voltage V1 and the source voltage V2 are approximately the same. In addition, the source voltage V1 has a voltage that is lower than the reference voltage VREF by a gate-source voltage of the transistor 142. The source voltage V2 is a voltage that is lower than the reference voltage VREF by a gate-source voltage of the transistor 143.

The comparison circuit 146 generates a normal logic signal as the output signal OPD in the case of the source voltage V1 and the source voltage V2 being equal, and outputs the output signal OPD to the PWM control circuit 123.

On the other hand, in the case of the voltage detection terminal 111 being open, the source voltage V2 of the transistor 143 begins to decrease. If the comparison circuit 146 detects a decrease in the source voltage V2 by a predetermined value or more than the source voltage V1, the comparison circuit 146 generates an abnormal logic signal as the output signal OPD and outputs the output signal OPD to the PWM control circuit 123.

The abnormal output signal OPD indicates the detection of the voltage detection terminal 111 being open. The abnormal output signal OPD is also recorded as an open detection signal. In addition, the abnormal output signal OPD is output to the PWM control circuit 123 as a stop signal indicating the high side FET 124 is controlled to be OFF. Therefore, in a case where the comparison circuit 146 detects the source voltage V2 of the transistor 143 is lower than the source voltage V1 of the transistor 142, the comparison circuit 146 outputs a stop signal to stop an output of the switching regulator 100. By the PWM circuit 123 controlling the high side FET 124 to be OFF, the output voltage VOUT decreases. Thus, it is possible to prevent an overvoltage of the output voltage VOUT.

As described above, according to the open protection circuit 120 of this embodiment, an overvoltage in an output voltage in the case of a voltage detection terminal for feedback-controlling being open may be reliably prevented, regardless of the deviation of elements within an integrated circuit.

In the conventional open protection circuit described in Patent Document 1, the current value of the pull-up current supplied from the current source is configured to be greater than the current value of the current flowing through the voltage dividing resistor. Due to the deviation of the current value of the current source, there may be a reversal between the current value of the pull-up current supplied from the current source and the current value of the current flowing through the voltage dividing resistor, it is possible that the conventional open protection circuit cannot function as a protective circuit.

In addition, in the conventional open protection circuit described in Patent Document 1, in the case of using a resistor instead of the current source, due to the synthesis method of the resistor, the environmental factors in addition to simple element characteristics may cause a deviation in the current value. For example, in response to the changing of the power supply voltage at a connecting object of the resistor, there may be a reversal between the current value flowing through the resistor and the current value of the current flowing through the voltage dividing resistor.

On the other hand, as described above, the open protection circuit 120 of this embodiment makes the structures of the constant current source 144 and the constant current source 145 identical to each other, and thus these current values are equal to each other. If the structures of the constant current source 144 and the constant current source 145 are made the same, even if there is a deviation in the constant current source 144 and a deviation in the constant current source 145, the deviations will occur in the same direction. Therefore, it is difficult to generate a difference between the source voltage V1 and the source voltage V2 during a time period during which no overvoltage is generated. Similarly, for the gate-source voltage of the transistor 142 and the transistor 143, by using the same type of elements, it is also difficult to generate a difference between the source voltage V1 and the source voltage V2. Therefore, in the open protection circuit 120, the sensitivity to the element deviation is low.

In the open protection circuit 120 of this embodiment, since the sensitivity to the deviation of the current source is low, the influence of the deviation of the current source may be ignored. In the open protection circuit 120, the PWM control circuit 123 is turned OFF only by the output signal OPD output from a logic circuit as the comparison circuit 146. In this sense, the open protection circuit 120 reliably functions.

In addition, in the conventional open protection circuit described in Patent Document 1, due to the use of a current source that flows a pull-up current on the feedback terminal side, there is a path for the pull-up current to flow to the feedback path, it is possible that the feedback path is affected by the noise of a power supply connecting to the current source.

On the other hand, the open protection circuit 120 of this embodiment is configured to add elements to the ground side. In the open protection circuit 120 of this embodiment, compared to the conventional open protection circuit which adds elements to the power supply side, it is less susceptible to the influence of noise.

### Second Embodiment

In the second embodiment, only in the case of the PWM control signal being a logic signal that turns ON the high side transistor, the first current source (the constant current source 144) and the second current source (the constant current source 145) is ON. This embodiment is described below.

FIG. 2 is a diagram illustrating a switching regulator according to the second embodiment.

In the case of comparing the switching regulator 200 (FIG. 2) according to this embodiment with the switching regulator 100 (FIG. 1) according to the first embodiment, the open protection circuit 220 is different.

Here, other structural components have the same functions as in the first embodiment. The same symbols may be used for the structures same as the first embodiment, and sometimes the description on the same structures and actions may be omitted.

The open protection circuit 220 includes a reference voltage source 141, a transistor 142, a transistor 143, a constant current source 144, a constant current source 145, a comparison circuit 146, a switch 151, and a switch 152. In the case of comparing the open protection circuit 220 (FIG. 2) with the open protection circuit 120 (FIG. 1), the difference is that in the open protection circuit 220, the switch 151 and the switch 152 are included in the open protection circuit 220 of the second embodiment.

Here, in the open protection circuit 220, other structural components have the same functions as the open protection circuit 120.

In addition, the switch 151 is an example of the first switch. The switch 152 is an example of the second switch.

The switch 151 is connected in series with the constant current source 144. The switch 151 is provided between the source of transistor 142 and the constant current source 144. The switch 152 and the constant current source 145 are connected in series. The switch 152 is provided between the source of the transistor 143 and the constant current source 145.

The switches 151 and 152 are switched ON and OFF respectively by the signal PWM output from the PWM control circuit 123. The signal PWM is a signal synchronized with the control signal for PWM controlling of the high side FET 124 and the low side FET 125 from the PWM control circuit 123. That is, the signal PWM is a signal synchronized with the control signal of the switching regulator 200.

In a state where the high side FET 124 is OFF, the signal PWM indicates the switch to be turned OFF. On the other hand, in a state where the high side FET 124 is ON, the signal PWM indicates the switch to be turned ON. Therefore, the switches 151 and 152 are controlled respectively by the signal PWM, so as to be turned OFF in a state where the high side FET 124 is OFF and turned ON in a state where the high side FET 124 is ON.

In the switching regulator 200, during a transition state where the high side FET 124 is turned ON and the output voltage VOUT increases, the open protection circuit 220 functions to prevent an overvoltage of the output voltage VOUT. On the other hand, in the case of the high side FET 124 being turned OFF, since the current of either the constant current source 144 or the constant current source 145 does not flow, it is possible to reduce the consumption current and improve efficiency. Therefore, in the open protection circuit 220, it is possible to perform the open protection action while reducing the current consumption.

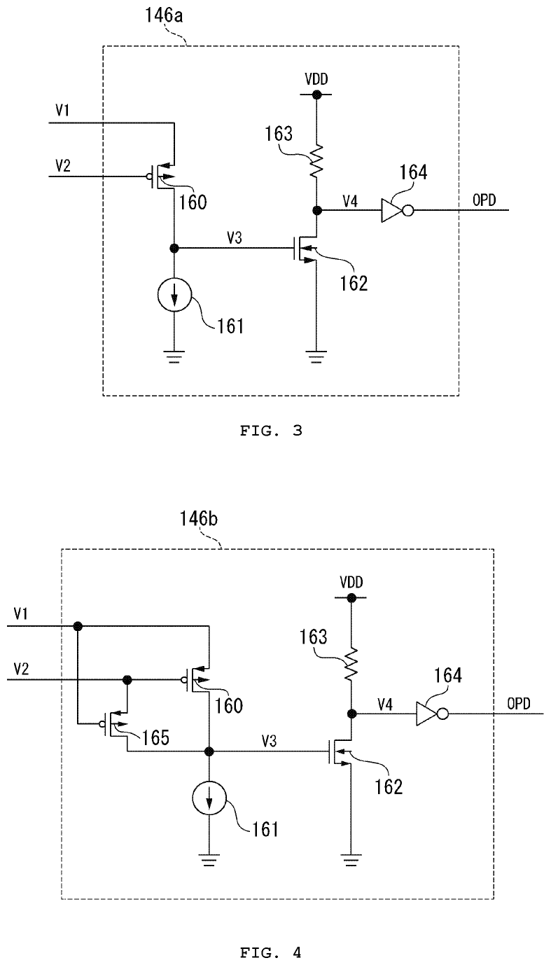

Next, with reference to FIGS. 3 and 4, the structure of the comparison circuit 146 will be described in detail.

FIG. 3 is a diagram illustrating a first example of the structure of comparison circuit according to various embodiments. In FIG. 3, as the first example of the structure of the comparison circuit 146, a comparison circuit 146a is illustrated. The comparison circuit 146a includes a PMOS transistor 160, a constant current source 161, an NMOS transistor 162, a resistor 163, and a logic circuit 164.

The source of the PMOS transistor 160 is connected to the source of the transistor 142, the gate of the PMOS transistor 160 is connected to the source of the transistor 143, and the drain of the PMOS transistor 160 is connected to the gate of the NMOS transistor 162 and the constant current source 161.

One end of the constant current source 161 is connected to the drain of the PMOS transistor 160, and the other end of the constant current source 161 is grounded.

The gate of the NMOS transistor 162 is connected to the drain of the PMOS transistor 160, the drain of the NMOS transistor 162 is connected to a logic circuit 164 and a resistor 163, and the source of the NMOS transistor 162 is grounded. Therefore, the voltage V3 as the drain voltage of the PMOS transistor 160 is provided to the gate of the NMOS transistor 162. In addition, the voltage V4 as the drain voltage of the NMOS transistor 162 is provided to the logic circuit 164.

One end of the resistor 163 is connected to the drain of the NMOS transistor 162, and the other end of the resistor 163 is supplied with a power supply voltage VDD.

The input terminal of the logic circuit 164 is connected to the drain of the NMOS transistor 162, and the output terminal of the logic circuit 164 is connected to the PWM control circuit 123. In response to the input voltage V4 being input, the logic circuit 164 outputs the output signal OPD obtained by inverting a value of the voltage V4 to the PWM control circuit 123.

In the comparison circuit 146a, due to the open circuit of the voltage detection terminal 111, the source voltage V2 decreases, the PMOS transistor 160 turns ON, and the voltage V3 increases. In response to the voltage V3 increasing, the NMOS transistor 162 turns ON, and the voltage V4 decreases. In response to the voltage V4 decreasing, the output of the logic circuit 164 becomes high, and the output signal OPD is output as an open detection signal.

On the other hand, in a case where the open circuit of the voltage detection terminal 111 is not detected, the PMOS transistor 160 and the NMOS transistor 162 are turned OFF respectively, and the consumption current does not flow, thus achieving the low current consumption.

FIG. 4 is a diagram illustrating a second example of the structure of comparison circuit according to various embodiments. In FIG. 4, as the second example of the structure of the comparison circuit 146, the comparison circuit 146b is illustrated. The comparison circuit 146b includes a PMOS transistor 160, a constant current source 161, a NMOS transistor 162, a resistor 163, a logic circuit 164, and a PMOS transistor 165.

Comparing the comparison circuit 146b (FIG. 4) and the comparison circuit 146a (FIG. 3), the difference is that the comparison circuit 146b further includes a PMOS transistor 165. Here, in the comparison circuit 146b, other structural elements have the same functions as the comparison circuit 146a.

The source of the PMOS transistor 165 is connected to the source of the transistor 143 and the gate of the PMOS transistor 160. The gate of the PMOS transistor 165 is connected to the source of the transistor 142 and the source of the PMOS transistor 160. The drain of the PMOS transistor 165 is connected to the gate of the NMOS transistor 162, the drain of the PMOS transistor 160, and the constant current source 161.

In response to the source voltage V1 decreasing due to the open circuit of the voltage detection terminal 112, the comparison circuit 146b outputs an open detection signal by turning ON the PMOS transistor 165. Therefore, in response to detecting that the source voltage of the transistor 142 is lower than the source voltage of the transistor 143, the comparison circuit 146b outputs a stop signal to stop the output of the switching regulator 100. That is, in the comparison circuit 146b, a stop signal is output not only in the case of the voltage detection terminal 111 being open, but also in the case of the voltage detection terminal 112 being open. The open circuit of the voltage detection terminal 112 as a fault detection terminal, is a potential fault unrelated to the overvoltage of the output voltage VOUT.

The comparison circuit 146b may also detect potential faults caused by the open faults in the voltage detection terminal 112. Therefore, compared to detecting only the overvoltage of the output voltage VOUT, it is possible to control the action of the switching regulator 100 or the switching regulator 200 in a safer state.

The embodiments of the present invention have been described above with reference to the accompanying drawings, however the specific structure is not limited to the above structure. In the implementation phase, in addition to the above examples, various implementing approaches may be used, and various omissions, substitutions, or changes may be made without departing from the spirit of the present invention.

For example, in the above embodiments, an example has been described where both the transistor 142 and the transistor 143 are NMOS transistors, but it is not limited to this. The transistors 142 and 143 may be PMOS transistors, respectively.

In addition, in the above embodiments, an example has been described where the voltage detection terminal 111 is connected to the feedback path including the voltage dividing resistor 121 and the voltage dividing resistor 122, but it is not limited to this. The feedback path connecting to the voltage detection terminal 111 does not need to be a feedback path including a voltage dividing resistor, as long as it may perform feedback-controlling based on the output voltage VOUT, the feedback path may have any structure.

In addition, in the above embodiments, an example has been described where an open protection circuit is provided in a switching regulator as an example of a DC-DC converter, but it is not limited to this. The open protection circuit of the embodiments may also be provided in the linear regulator.

In addition, an example has been described where the PWM control circuit controls the high side FET and the low side FET, however the control method of the control circuit for the high side FET and the low side FET is not limited to PWM controlling. The control scheme may be, for example, Pulse Frequency Modulation (PFM) controlling or Constant On Time (COT) controlling.

These embodiments and their variations are included within the scope or spirit of the present invention, and are included within the scope and equal scope of the present invention as claimed in the claims.

What is claimed is:

1. An open protection circuit having a circuit for feedback-controlling an output voltage of an output terminal to a predetermined voltage, the open protection circuit comprising:
a plurality of voltage detection terminals connected to the output terminal, at least one of the plurality of voltage detection terminals being connected to a path for feedback-controlling, and circuitry configured to compare voltages of the plurality of voltage detection terminals and stop an output of the output voltage in response to detecting a predetermined potential difference.

2. The open protection circuit according to claim 1, comprising:
a first voltage detection terminal connected to the output terminal;
a second voltage detection terminal connected to the output terminal and connected to the path for feedback-controlling;
a first transistor having a drain connected to the first voltage detection terminal;
a second transistor having a drain connected to the second voltage detection terminal;
a first current source connected to a source of the first transistor;
a second current source connected to a source of the second transistor;
a reference voltage source configured to supply voltage to a gate of the first transistor and a gate of the second transistor respectively;
a comparison circuit configured to compare a source voltage of the first transistor with a source voltage of the second transistor,
wherein the comparison circuit is configured to output a stop signal to stop the output of the output voltage in response to detecting a predetermined potential difference between the source voltage of the second transistor and the source voltage of the first transistor.

3. A switching regulator comprising:
the open protection circuit according to claim 2.

4. The switching regulator according to claim 3, wherein the open protection circuit further comprising:
a first switch provided between the source of the first transistor and the first current source;
a second switch provided between the source of the second transistor and the second current source,
the first switch and the second switch are switched ON and OFF respectively by a signal synchronized with the control signal of the feedback-controlling.
